(19) United States
(12) Patent Application Publication
(10) Pub. No.: US 2023/0411976 A1
(43) Pub. Date: Dec. 21, 2023

(54) MOBILE POWER SUPPLY, MOBILE POWER SUPPLY MANAGEMENT DEVICE AND MOBILE POWER SUPPLY SYSTEM

(71) Applicant: Ninebot Commercial (Beijing) Technology Co., LTD., Beijing (CN)

(72) Inventors: Jiankun ZHAO, Beijing (CN); Chen HU, Beijing (CN); Jinsheng ZHU, Beijing (CN)

(21) Appl. No.: 18/211,388

(22) Filed: Jun. 19, 2023

(30) Foreign Application Priority Data
Jun. 20, 2022 (CN) 202210701383.X

(51) Int. Cl. H02J 7/00

(52) U.S. Cl. CPC H02J 7/0045; H02J 7/00032

(57) ABSTRACT

A mobile power supply system includes a mobile power supply management device and one or more cascaded mobile power supplies. The mobile power supply includes a battery and a battery control circuit. The mobile power supply management device includes at least one of a direct-current discharge circuit and an alternating-current discharge circuit. The mobile power supply management device is used for managing charging and discharging of a battery of the mobile power supply. The mobile power supply management device and the one or more cascaded mobile power supplies are detachably and mechanically connected. The number and power of the mobile power supplies of the mobile power supply system can be adjusted according to requirements, and different battery capacities and discharging capacities are achieved.

### CROSS-REFERENCE TO RELATED APPLICATIONS

This application claims priority to and benefits of Chinese Patent Application No. 202210701383.X, filed on Jun. 20, 2022, the entire content of which is incorporated herein by reference.

### FIELD

This application relates to the field of mobile power supply technology, and more particularly to a mobile power supply, a mobile power supply management device, and a mobile power supply system.

### BACKGROUND

There are more and more types of electric devices and constantly expanding electricity usage scenarios. Mobile power supplies (also known as portable power supplies) are becoming increasingly widespread and frequently used. Mobile power supplies can solve a problem of how to charge outdoor devices, portable electronic products, and other electric devices. Different electricity usage scenarios have different requirements for the battery capacity and discharge power of mobile power supplies, and mobile power supplies of a single model are difficult to meet personalized electricity needs. However, designing and producing corresponding models of mobile power supplies for each application scenario may result in complex models of mobile power supplies, which is not conducive to user selection.

### SUMMARY

According to a first aspect of embodiments of the present disclosure, a mobile power supply is provided. The mobile power supply includes: a first housing enclosing and forming a first space; a battery accommodated in the first space; a battery control circuit coupled to the battery and accommodated in the first space; a first communication module coupled to the battery control circuit and accommodated in the first space, the first communication module being configured to communicate with a mobile power supply management device; a first power interface module arranged on the first housing and configured for power connection between the battery and the mobile power supply management device; a first mechanical connection mechanism arranged on the first housing, the first mechanical connection mechanism being configured to cooperate with a mechanical connection structure of an upper-level mobile power supply to mechanically connect the mobile power supply with the upper-level mobile power supply; and a second mechanical connection mechanism arranged on the first housing and spaced apart from the first mechanical connection mechanism, the second mechanical connection mechanism being configured to cooperate with a mechanical connection structure of a lower-level mobile power supply to mechanically connect the mobile power supply with the lower-level mobile power supply.

According to a second aspect of embodiments of the present disclosure, a mobile power supply management device is provided. The mobile power supply management device includes: a second housing enclosing and forming a second space; a discharge circuit accommodated in the second space; a second power interface module arranged on the second housing and configured for power connection between the mobile power supply management device and a battery of a mobile power supply: a second communication module configured to communicate with a battery control circuit of the mobile power supply and accommodated in the second space; and a third mechanical connection mechanism arranged on the second housing, the third mechanical connection mechanism being configured to cooperate with a mechanical connection structure of the mobile power supply to mechanically connect the mobile power supply management device with the mobile power supply.

According to a third aspect of embodiments of the present disclosure, a mobile power supply system is provided. The mobile power supply system includes: one or more mobile power supplies and a mobile power supply management device. Each mobile power supply includes: a first housing enclosing and forming a first space; a battery accommodated in the first space; a battery control circuit coupled to the battery and accommodated in the first space: a first communication module coupled to the battery control circuit and accommodated in the first space, the first communication module being configured to communicate with a mobile power supply management device; a first power interface module arranged on the first housing and configured for power connection between the battery and the mobile power supply management device; a first mechanical connection mechanism arranged on the first housing, the first mechanical connection mechanism being configured to cooperate with a mechanical connection structure of an upper-level mobile power supply to mechanically connect the mobile power supply with the upper-level mobile power supply; and a second mechanical connection mechanism arranged on the first housing and spaced apart from the first mechanical connection mechanism, the second mechanical connection mechanism being configured to cooperate with a mechanical connection structure of a lower-level mobile power supply to mechanically connect the mobile power supply with the lower-level mobile power supply. The mobile power supply management device includes: a second housing enclosing and forming a second space; a discharge circuit accommodated in the second space; a second power interface module arranged on the second housing and configured for Power connection between the mobile power supply management device and a battery of a mobile power supply; a second communication module configured to communicate with a battery control circuit of the mobile power supply and accommodated in the second space; and a third mechanical connection mechanism arranged on the second housing, the third mechanical connection mechanism being configured to cooperate with a mechanical connection structure of the mobile power supply to mechanically connect the mobile power supply management device with the mobile power supply. The mobile power supply management device sends an activation signal to the mobile power supply through the second communication module, and the activation signal is used to activate a battery control circuit of the mobile power supply.

### BRIEF DESCRIPTION OF DRAWINGS

In order to explain embodiments of the present disclosure or technical solutions in the related art more clearly, drawings used in description of the embodiments or the related art will be briefly introduced. The drawings in the following description illustrate some embodiments of the present disclosure. For ordinary technical personnel in the art, other drawings can be obtained based on these drawings without any creative effort.

FIG. 1 is a block diagram of a mobile power supply according to embodiments of the present disclosure.

FIG. 2 is a block diagram of a mobile power supply management device according to embodiments of the present disclosure.

FIG. 3 is a block diagram of another mobile power supply management device according to embodiments of the present disclosure.

FIG. 4 is a block diagram of still another mobile power supply management device according to embodiments of the present disclosure.

FIG. 5 is a block diagram of a mobile power supply system according to embodiments of the present disclosure.

FIG. 6 is a block diagram of another mobile power supply system according to embodiments of the present disclosure.

FIG. 7 is a block diagram of still another mobile power supply system according to embodiments of the present disclosure.

FIG. 8 is a block diagram of a radio frequency communication control circuit,

FIG. 9 shows a workflow of the mobile power supply system in FIG. 7.

FIG. 10 is a perspective view of a mobile power supply according to embodiments of the present disclosure,

FIG. 11 is a perspective view of a mobile power supply management device according to embodiments of the present disclosure.

FIG. 12 is a schematic view of a mobile power supply system in an uncombined state according to a first embodiment of the present disclosure.

FIG. 13 is a schematic view of a mobile power supply system in an uncombined state according to a third embodiment of the present disclosure.

FIG. 14 is a schematic view of a mobile power supply system in an uncombined state according to a fourth embodiment of the present disclosure.

FIG. 15 is a sectional view of the mobile power supply system in a combined state according to the fourth embodiment of the present disclosure.

### DETAILED DESCRIPTION

In order to allow technical personnel in the art to better understand technical solutions of the present disclosure, the technical solutions in embodiments of the present disclosure will be described clearly and completely with reference to the drawings. The described embodiments are part rather than all of the embodiments of the present disclosure, Based on the embodiments in the present disclosure, all other embodiments obtained by ordinary technical personnel in the art without any creative effort fall into the protection scope of the present disclosure.

A mobile power supply in the related art is in the form of a single unit, which integrates functional modules such as a battery, AC discharge (inverter discharge) and DC discharge modules within a shell. Mobile power supply manufacturers need to design corresponding models for different battery capacities and power requirements, resulting in a variety of and complexity of mobile power supply models. When faced with different application requirements for battery capacity and power, users need to purchase different models of mobile power supplies, leading to higher cost.

Embodiments of the present disclosure provide a mobile power supply, a mobile power supply management device, and a mobile power supply system. The mobile power supply system includes a mobile power supply management device and one or more mobile power supplies. Each mobile power supply includes a battery used to power an external electric device, and a discharge circuit in the mobile power supply management device is used to implement a process of supplying power to the external electric device by the battery of the mobile power supply. Each of the mobile power supply management device and the mobile power supplies is provided with a communication module, enabling the mobile power supply management device to manage charging and discharging processes of the mobile power supply, Each of the mobile power supply management device and the mobile power supplies is provided with a mechanical connection mechanism to achieve detachable mechanical connection between the mobile power supply management device and the mobile power supplies, allowing users to combine the mobile power supplies and the mobile power supply management device according to personalized needs. For example, users can make choices and combinations about the number, the battery capacity, and power of mobile power supplies.

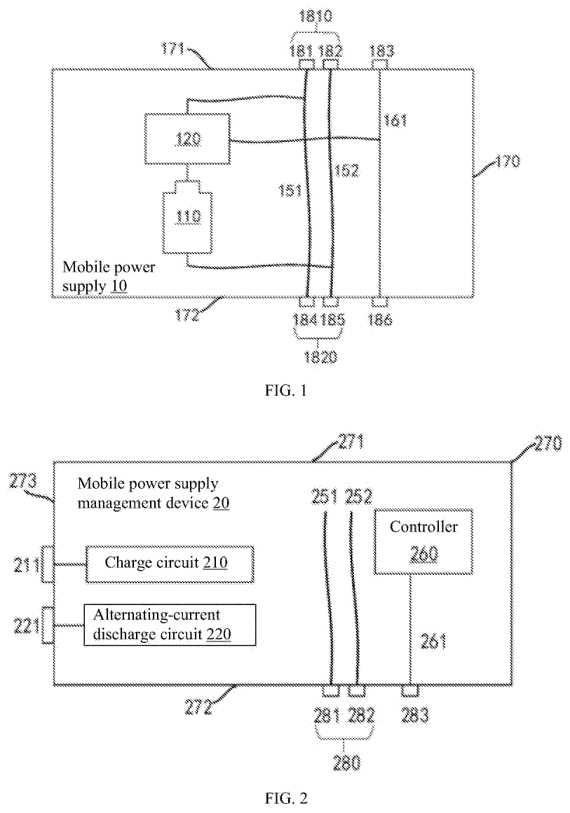

FIG. 1 is a block diagram of the mobile power supply according to embodiments of the present disclosure. The mobile power supply 10 includes: a first housing 170, a battery 110, a battery control circuit 120, a first communication module, a first power interface module, a first mechanical connection mechanism, and a second mechanical connection mechanism (not shown in FIG. 1). The first housing 170 includes an upper wall 171, a lower wall 172, and a plurality of side walls, enclosing and forming a first space. The battery 110, the first communication module, > and the battery control circuit 120 are arranged in the first space. The first housing 170 protects components arranged in the first space. The first mechanical connection mechanism and the second mechanical connection mechanism are arranged on the first housing 170, and the first mechanical connection mechanism and the second mechanical connection mechanism are spaced apart from each other. The mobile power supply 10 is also known as a battery pack. The mobile power supply 10 herein is a battery pack that does not include charging and discharge circuits.

The battery 110 is used to power an electric device. The battery 110 is a secondary battery (also known as a rechargeable battery or an accumulator), such as a lithium-ion battery. In some embodiments, the battery 110 is a battery set including a plurality of secondary batteries that are connected in series or in parallel. The battery control circuit 120 is coupled to the battery 110 and is used to monitor a status of the battery 110, including a voltage, a charge current, a discharge current, and a temperature of the battery 110. When it is monitored that the battery 110 is subject to overcharge, over-discharge, overcurrent, short circuit, excessive power, overheating and the like, the battery control circuit 120 sends an alarm signal. The alarm signal is sent to the mobile power supply management device through the first communication module of the mobile power supply 10. The first communication module is used for communication between the mobile power supply 10 and the mobile power supply management device. For example, the first communication module is used for communication between the battery control circuit 120 of the mobile power supply 10 and the mobile power supply management device. The first communication module is at least one of a physical communication module, a power carrier communication module, and a radio frequency communication module. The first power interface module is used for power connection between the battery 110 and the mobile power supply management device, thereby coupling the battery 110 to a discharge circuit or a charge circuit of the mobile power supply management device.

The first mechanical connection mechanism is used to cooperate with a mechanical connection structure of the mobile power supply management device or an upper-level mobile power supply (an external upper-level mobile power supply of the current mobile power supply), to mechanically connect the mobile power supply 10 with the mobile power supply management device or the upper-level mobile power supply. After the mechanical connection is completed, the mobile power supply management device or the upper-level mobile power supply is for example located above the mobile power supply 10, The second mechanical connection mechanism is used to cooperate with a mechanical connection structure of a lower-level mobile power supply (an external lower-level mobile power supply of the current mobile power supply), to mechanically connect the mobile power supply 10 with the lower-level mobile power supply. After the mechanical connection is completed, the lower-level mobile power supply is for example located below the mobile power supply 10. The first mechanical connection mechanism and the second mechanical connection mechanism include at least one of screw connection, buckle connection, and sliding connection.

The mobile power supply 10 also includes busbars 151 and 152. The busbars 151 and 152 are coupled to a positive pole (also known as an anode) and a negative pole (also known as a cathode) of the battery 110, respectively. The busbars 151 and 152 are a positive-side busbar and a negative-side busbar, respectively. The battery control circuit 120 is arranged between the positive pole of the battery 110 and the busbar 151, for example. The battery control circuit 120 has a working state and a sleep state, and the sleep state has lower power consumption than the working state. In response to an activation signal sent by the mobile power supply management device, the battery control circuit 120 enters the working state from the sleep state.

The first power interface module is arranged on the first housing 170, and includes a first power interface unit 1810 and a second power interface unit 1820. The first power interface unit 1810 is arranged, for example, on the upper wall 171 of the first housing 170 and is used for power connection between the mobile power supply 10 and the mobile power supply management device or the upper-level mobile power supply. The second power interface unit 1820 is arranged, for example, on the lower wall 172 of the first housing 170 and is used for power connection between the mobile power supply 10 and the lower-level mobile power supply. The first power interface unit 1810 includes a busbar interface 181 (a first busbar interface) and a busbar interface 182 (a second busbar interface). The second power interface unit 1820 includes a busbar interface 184 (a third busbar interface) and a busbar interface 185 (a fourth busbar interface). The busbar 151 has a first end coupled to the busbar interface 181 and a second end coupled to the busbar interface 184. The busbar 152 has a first end coupled to the busbar interface 182 and a second end coupled to the busbar interface 185.

In some embodiments, the first communication module is a physical communication module, and includes a signal line 161, a communication interface 183, and a communication interface 186, The signal line 161 is, for example, a communication bus. The signal line 161 serves as a communication path between the battery control circuit 120 and the mobile power supply management device. The signal line 161 has a first end coupled to the communication interface 183 and a second end coupled to the communication interface 186. It can be understood that the mobile power supply 10 can include a plurality of signal lines 161, each of which is configured with a pair of communication interfaces 183 and 186. The communication between the mobile power supply 10 and the mobile power supply management device is based on one or more of 12C, SPI and DART, for example. In some embodiments, the communication interface 183 and the first power interface unit 1810 are integrated together, while the communication interface 186 and the second power interface unit 1820 are integrated together.

In some embodiments, the first communication module is a radio frequency communication module, and the mobile power supply 10 communicates with the mobile power supply management device or other mobile power supplies through radio frequency communication. The radio frequency communication involves for example a RFID chip. Through communication by the radio frequency communication module, the mobile power supply 10 does not require the signal line 161, the communication interface 183, or the communication interface 186.

In some embodiments, the first communication module is a power carrier communication module, and the mobile power supply 10 communicates with the mobile power supply management device or other mobile power supplies through power carrier communication. The mobile power supply 10 also includes a carrier signal generation circuit and a carrier signal reception circuit. The carrier signal generation, circuit is used to generate a power carrier signal based on information to be transmitted, and load the power carrier signal onto the busbar 151 (a first busbar) or the busbar 152 (a second busbar). The information to be transmitted is for example monitoring information on the battery 110 reported by the battery control circuit 120. The carrier signal reception circuit is used to detect a power carrier signal sent by the mobile power supply management device from the busbar 151 or 152, and the power carrier signal sent by the mobile power supply management device, for example, carries a control command.

When the mobile power supply 10 is mechanically connected to the mobile power supply management device or the upper-level mobile power supply, the first power interface module of the mobile power supply 10 is docked with a power interface module of the mobile power supply management device or of the upper-level mobile power supply to achieve power connection between the mobile power supply 10 and the mobile power supply management device or another mobile power supply, thereby connecting the battery 110 of the mobile power supply 10 to the discharge circuit in the mobile power supply management device.

Embodiments of the present disclosure provides a mobile power supply management device that includes a second housing, a discharge circuit, a second power interface module, a second communication module, and a third mechanical connection mechanism. The second housing encloses and forms a second space. The discharge circuit and the second communication module are arranged in the second space. The second power, interface module and the third mechanical connection mechanism are arranged on the second housing. The discharge circuit is used to achieve power supply of the battery 110 of the mobile power supply 10 to the electric device. The discharge circuit includes at least one of a direct-current discharge circuit and an alternating-current discharge circuit. The second power interface module is used for power connection between the mobile power supply management device and the battery of the mobile power supply. The second communication module is used for communication between the mobile power supply management device and the mobile power supply. The third mechanical connection mechanism is used to cooperate with a mechanical connection structure of the mobile power supply, to mechanically connect the mobile power supply management device with the mobile power supply. The mobile power supply management device will be described below through several embodiments.

FIG. 2 is a block diagram of a mobile power supply management device according to embodiments, of the present disclosure. The mobile power supply management device 20 includes a second housing 270, an alternating-current discharge circuit 220, a second power interface module 280, a second communication module, and a third mechanical connection mechanism (not shown in FIG. 2). The second housing 270 encloses and forms a second space, and includes an upper wall 271, a lower wall 272, and a plurality of side walls. The alternating-current discharge circuit 220 is arranged in the second space. In this embodiment, the discharge circuit is the alternating-current discharge circuit 220. The alternating-current discharge circuit 220 is used to realize alternating-current discharge of the battery 110 of the mobile power supply 10. The alternating-current discharge circuit 220 can provide 220V AC power for the electric device, for example. The alternating-current discharge circuit 220 includes a DC-to-AC inverter. The electric device may be an electric tool, a mobile phone charger and the like.

The second power interface module 280 is for example arranged on the lower wall 272 of the second housing 270 and used for power connection between the mobile power supply management device 20 and the battery 110 of the mobile power supply 10. The second power interface module 280 includes a busbar interface 281 (a fifth busbar interface) and a busbar interface 282 (a sixth busbar interface). The third mechanical connection mechanism is used to cooperate with a mechanical connection structure of the mobile power supply 10, to mechanically connect the mobile power supply management device 20 with the mobile power supply 10. The third mechanical connection mechanism includes one or more of a screw connection mechanism, a buckle connection mechanism, and a sliding connection mechanism. The second communication module is used for communication between the mobile power supply management device 20 and the mobile power supply 10. The second communication module is at least one of a physical communication module, a power carrier communication module, and a radio frequency communication module.

The mobile power supply management device 20 also includes a busbar 251 (a third busbar) and a busbar 252 (a fourth busbar). The busbars 251 and 252 are a positive-side busbar and a negative-side busbar, respectively. The busbar 251 is coupled to the busbar interface 281, and the busbar 252 is coupled to the busbar interface 282, The alternating-current discharge circuit 220 is coupled to the battery of the mobile power supply 10 through the busbars 251 and 252.

The mobile power supply management device 20 also includes a charge circuit 210 that is used to charge the battery in the mobile power supply 10. The charge circuit charges the battery 110 according to a predetermined charging algorithm based on information (such as the voltage and charge current) about the battery 110 provided by the battery control circuit 120 of the mobile power supply 10.

The mobile power supply management device 20 also includes a charging interface 211 and an alternating-current discharging interface 221 arranged on the side walls 273 of the second housing 270. An input end of the charge circuit 210 is coupled to the charging interface 211 and is coupled to an external power supply through the charging interface 211. An output end of the charge circuit 210 is coupled to the busbars 251 and 252. An input end of the alternating-current discharge circuit 220 is coupled to the busbars 251 and 252, and an output end thereof is coupled to the alternating-current discharging interface 221. AC power is supplied to the electric device through the alternating-current discharging interface 221.

The mobile power supply management device 20 also includes a controller 260. The controller 260 sends commands to the charge circuit 210 and the discharge circuit 220 based on information such as voltage, charge current, and discharge current about the battery 110 provided by the battery control circuit 120.

In the embodiment shown in FIG. 2, the second communication module of the mobile power supply management device 20 is a physical communication module, and the second communication module includes a signal line 261 and a communication interface 283. When the mobile power supply management device 20 and the mobile power supply 10 are mechanically connected, the controller 260 is coupled to the battery control circuit 120 in the mobile power supply 10 through the signal line 261 and the communication interface 283. In some embodiments, the mobile power supply management device 20 does not include the signal line 261 or the communication interface 283, and the controller 260 communicates with the battery control circuit 120 in the mobile power supply 10 through RFID or power carrier communication.

In some embodiments, the mobile power supply management device 20 also includes a third communication module, and the controller 260 can communicate with an electronic device at a user side through the third communication module. The third communication module, for example, is a Wi-Fi module. The electronic device at the user side may be a control device of the mobile power supply management device 20 or a mobile electronic device running a control program.

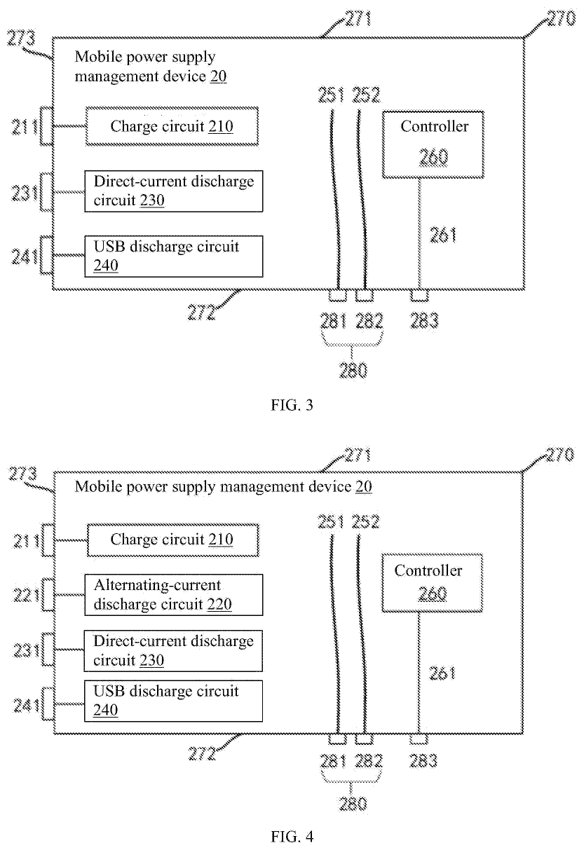

FIG. 3 is a block diagram of another mobile power supply management device according to embodiments of the present disclosure. The mobile power supply management device 20 includes a second housing 270, a direct-current discharge circuit 230, a second power interface module 280, a second communication module, and a third mechanical connection mechanism (not shown in FIG. 3). In this embodiment, the discharge circuit is the direct-current discharge circuit 230. The second communication module and the direct-current discharge circuit 230 are arranged in a second space defined by the second housing 270. The battery 110 of the mobile power supply 10 supplies power to the electric device through the direct-current discharge circuit 230. The three t-current discharge circuit 230 can, provide, for example, 12V DC power for the electric device. The direct-current discharge circuit 230 includes a DC-to-DC converter. The mobile power supply management device 20 also includes a USB discharge circuit 240. The USB discharge circuit 240 includes, for example, a buck circuit that, is coupled to the direct-current discharge circuit 230. The USB discharge circuit 240 can provide lower voltage DC power, and for example, reduce the 12V DC power provided by the direct-current discharge circuit 230 to 5V DC power.

The second power interface module 280 is on the lower wall 272 of the second housing 270 and is used for power connection between the mobile power supply management device 20 and the mobile power supply. The second power interface module 280 includes a busbar interface 281 and a busbar interface 282. The third mechanical connection mechanism is used to cooperate with the mechanical connection structure of the mobile power supply 10, to mechanically connect the mobile power supply management device 20 with the mobile power supply 10. The third mechanical connection mechanism includes one or more of a screw connection mechanism, a buckle connection mechanism, and a sliding connection mechanism. The second communication module is used for communication between the mobile power supply management device 20 and the mobile power supply 10. The second communication module is at least one of a physical communication module, a power carrier communication module, and a radio frequency communication module.

The mobile power supply management device 20 also includes a charge circuit 210 that is used to charge the battery in the mobile power supply 10. The mobile power supply management device 20 also includes busbars 251 and 252 that are a positive-side busbar and a negative-side busbar, respectively. The busbar 251 is coupled to the busbar interface 281, and the busbar 252 is coupled to the busbar interface 282. The charge circuit 210 and the direct-current discharge circuit 230 are coupled to the busters 251 and 252.

The mobile power supply management device 20 also includes a controller 260. The controller 260 sends commands to the charge circuit 210 and the discharge circuit 220 based on information such as voltage, charge current, and discharge current about the battery 110 provided by the battery control circuit 120. In the embodiment shown in FIG. 3, the second communication module of the mobile power supply management device 20 is a physical communication module that includes a signal line 261 and a communication interface 283. When the mobile power supply management device 20 and the mobile power supply 10 are mechanically connected, the controller 260 communicates and connects with the battery control circuit 120 in the mobile power supply 10 through the signal line 261 and the communication interface 283. In some embodiments, the mobile power supply management device 20 does not include the signal line 261 or the communication interface 283, and the controller 260 communicates with the battery control circuit 120 in the mobile power supply 10 through RFID or power carrier communication.

The mobile power supply management device 20 further includes a charging interface 211, a direct-current discharging interface 231, and a USB interface 241 arranged on the side walls 273 of the second housing 270. Users can choose one or more of the direct-current discharging interface 231 and the USB interface 241 based on the type of the electric device. An input end of the charge circuit 210 is coupled to the charging interface 211 and is coupled to an external power through the charging interface 211. An output end of the charge circuit 210 is coupled to the busbars 251 and 252. An input end of the direct-current discharge circuit 230 is coupled to the busbars 251 and 252 and is coupled to the battery 110 in the mobile power supply 10 through the second power interface module and the busbars 251 and 252. An output end of the direct-current discharge circuit 230 is coupled to the direct-current discharging interface 231, In some embodiments, the direct-current discharging interface 231 can charge a car battery by coupling it to a car cigarette lighter interface. An output end of the USB discharge circuit 240 is coupled to the USB interface 241. The USB interface 241 includes one or more of type-A, type-B, and type-C.

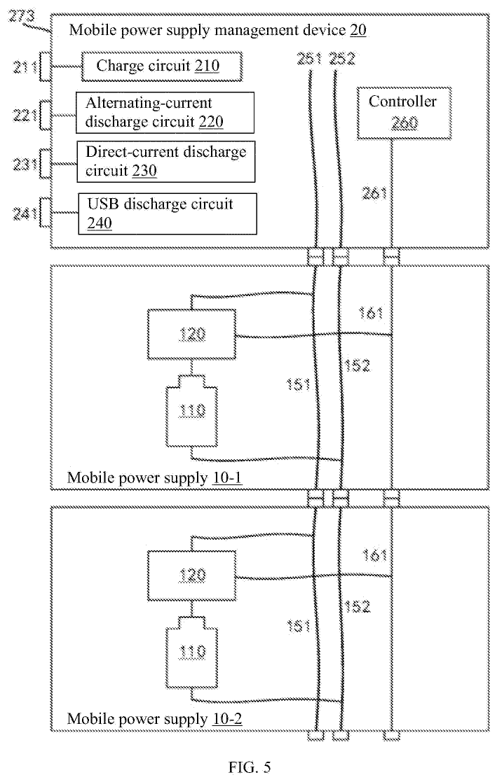

FIG. 4 is a block diagram of still another mobile power supply management device according to embodiments of the present disclosure. The mobile power supply management device in FIG. 4 includes a charge circuit 210, an alternating-current discharge circuit 220, a direct-current discharge circuit 230, a USB discharge circuit 240, a second housing 270, a second power interface module 280, a second communication module, and a third mechanical connection mechanism (not shown in FIG. 4), That is, the mobile power supply management device shown in FIG. 4 not only includes the direct-current discharge circuit but also the alternating-current discharge circuit. Correspondingly, the mobile power supply management device includes a charging interface 211, an alternating-current discharging interface 221, a direct-current discharging interface 231, and a USB interface 241,

FIG. 10 is a perspective view of a mobile power supply according to embodiments of the present disclosure, and FIG. 11 is a perspective view of a mobile power supply management device according to embodiments of the present disclosure. As shown in FIGS. 10 and 11, the mobile power supply 10 and the mobile power supply management device 20 are cubic. A buffer 177 is arranged at a top corner of the mobile power supply 10 and covers the top corner of the mobile power supply 10. A buffer 277 is arranged at a top corner of the mobile power supply management device 20 and covers the top corner of the mobile power supply management device 20. The material of the buffers 177 and 277, for example, is rubber. In some embodiments, the mobile power supply 10 has the same length and width as the mobile power supply management device 20. When the mobile power supply 10 and the mobile power supply management device 20 are combined through mechanical connection, the combination is cubic. As shown in FIG. 11, the charging interface 211, the alternating-current discharging interface 221, the direct-current discharging interface 231, and the USB interface 241 are arranged on the side walls 273 of the second housing 270 of the mobile power supply management device 20. The USB interface 241 includes a USB interface 241a, which is a USB type-A or type-B interface, and a USB interface 241b, which is A USB type-C interface.

The present disclosure also provides a mobile power supply system that includes a mobile power supply management device and one or more mobile power supplies. The mobile power supply management device is, for example, the mobile power supply management device 20. The one or more mobile power supplies are, for example, the mobile power supplies 10. The mobile power supply management device 20 and the one or more mobile power supplies 10 are detachably mechanically connected. The mobile power supply management device 20 and the one or more mobile power supplies 10 are detachably mechanically connected, for example, through one or more of a screw connection mechanism, a buckle connection mechanism, and a sliding connection mechanism. The mobile power supply management device 20 and the one or more mobile power supplies 10 are combined through mechanical connection. Through the mechanical connection, a second power interface module 280 of the mobile power supply management device is correspondingly coupled to a first power interface unit 1810 of the mobile power supply, and the first power interface unit is coupled to a second power interface unit of an adjacent mobile power supply, to achieve power connection between a charge circuit and a discharge circuit of the mobile power supply management device 20 and the battery/batteries 110 of one or more mobile power supplies 10. The mobile power supply management device 20 sends an activation signal to the mobile power supply 10 through the second communication module, and the activation signal activates the battery control circuit 120 of the mobile power supply, for example, causing the battery control circuit 120 to enter the working state from the sleep state. The batteries 110 in one or more mobile power supplies 10 are connected in parallel through a busbar. Users can combine the mobile power supplies and the mobile power supply management device based on personalized power requirements. The mobile power supply management device and the one or more mobile power supplies in the mobile power supply system are all replaceable. For example, users can choose the power of the discharge circuit of the mobile power supply management device according to their needs.

Users can control batteries 110 in a plurality of mobile power supplies 10 for synchronous charging or discharging. For the synchronous discharging of the plurality of mobile power supplies, the batteries of the plurality of mobile power supplies are connected in parallel through the busbar, which is suitable for scenarios with high discharge power requirements. Users can also control some of the batteries of the plurality of mobile power supplies 10 to be charged or discharged and the remaining of the batteries of other mobile power supplies 10 not to be charged or discharged. The controller 260 of the mobile power supply management device 20 sends a command to the battery control circuit 120 of each mobile power supply 10 to achieve synchronous charging/synchronous discharging or partial charging/partial discharging. Users can also implement personalized charging and discharging schemes through customized methods, Users can configure the above charging and discharging schemes through a touch screen on the mobile power supply management device or through communication between the aforementioned electronic device and the mobile power supply management device. For example, users can configure a discharging scheme for the mobile power supply 10 through a mobile APP and send the discharging scheme to the controller 260 through the second communication module of the mobile power supply management device 20.

A personalized charging scheme is as follows. The mobile power supply system includes the mobile power supply management device 20 and the plurality of mobile power supplies 10. The battery 110, for example, adopts a constant-current constant-voltage charging method. Due to differences in battery capacity and remaining power of batteries 110 of the plurality of mobile power supplies 10, the time points at which the plurality of mobile power supplies 10 transition from constant-current charging to constant-voltage charging are different. The controller 260 of the mobile power supply management device 20 determines a charging status of the battery 110 of each mobile power supply 10 based on battery information sent by the battery control circuit 120 of each of the plurality of mobile power supplies 10, The controller 260 sends a charging pause command to a mobile power supply 10 that has completed a constant-current charging phase. When the batteries 110 of all the mobile power supplies 10 have completed the constant-current charging phase, the controller 260 sends a charging recovery command to the paused mobile power supply 10, and the batteries 110 of the plurality of mobile power supplies 10 enter a constant-voltage charging phase.

Another personalized charging scheme is as follows. The mobile power supply system includes the mobile power supply management device 20 and the plurality of mobile power supplies 10. When the batteries 110 of the plurality of mobile power supplies 10 are charged, the mobile power supply management device 20 determines a current power level of each battery 110 of the plurality of mobile power supplies 10, and the charge circuit 210 prioritizes charging the battery 110 with the lowest power level. The batteries 110 of the plurality of mobile power supplies 10 are charged in sequence. After the battery 110 of one mobile power supply 10 is fully charged, the battery 110 of the next mobile power supply 10 is charged. Alternatively, the battery with the lowest remaining power among the batteries of the plurality of mobile power supplies 10 is chosen to be first charged; when the battery is charged to reach the second lowest remaining power among the batteries of the plurality of mobile power supplies 10, the batteries of these two mobile power supplies 10 are charged simultaneously, and so on until the batteries of all the mobile power supplies 10 are fully charged.

A personalized discharging scheme is as follows. The mobile power supply system includes the mobile power supply management device 20 and the plurality of mobile power supplies 10. When the mobile power supply system supplies power to the electric device, the mobile power supply management device 20 determines a current power level of each battery 110 of the plurality of mobile power supplies 10. The controller 260 of the mobile power supply management device sends a command to the battery control circuit 120 of each mobile power supply 10, The battery control circuit 120 of the mobile power supply 10 having the battery 10 at the highest power level couples the battery 110 to the busbars 151 and 152, to supply power to the electric device through the discharge circuit of the mobile power supply management device 20. The batteries of the other mobile power supplies 10 do not supply power. That is, the battery 10 at the highest power level is first used to supply power to the electric device. When a voltage of this battery 110 drops to a voltage corresponding to a battery 10 at the second highest power level, the controller 260 of the mobile power supply management device 20 sends a command, and the battery at the highest power level and the battery 10 at the second highest power level are connected in parallel to supply power to the electric device together, and so on until the power supply is finished.

FIG. 5 is a block diagram of a mobile power supply system according to embodiments of the present disclosure. The mobile power supply system includes a mobile power supply management device 20 and two mobile power supplies 10-1 and 10-2. After the mechanical connection between the mobile power supply management device 20 and the two mobile power supplies 10-1 and 10-2 is achieved through a mechanical connection mechanism, a second power interface module 280 of the mobile power supply management device 20 is docked with a first power interface unit 1810 of the mobile power supply 10-1, and a second power interface unit 1820 of the mobile power supply is docked with a first power interface unit 1810 of the mobile power supply 10-2. In this way, a busbar 251 of the mobile power supply management device 20 and busbars 151 of the mobile power supplies 10-1 and 10-2 are coupled together, and a busbars 252 of the mobile power supply management device 20 and busbars 152 of the mobile power supplies 10-1 and 10-2 are coupled together. A signal line 261 of the mobile power supply management device 20 is coupled to signal lines 161 of the mobile power supplies 10-1 and 10-2. In some embodiments, the signal line 261 of the mobile power supply management device 20 includes an activation signal line, and the signal lines 161 of the mobile power supplies 10-1 and 10-2 include activation signal lines. A controller 260 of the mobile power supply management device 20 sends an activation signal to a target mobile power supply 10. The activation signal is used to activate the battery control circuit 120, Before receiving the activation signal, the battery control circuit 20 is in a sleep state or in a low power consumption state, and the activation signal causes the power management device 20 to enter a working state. In this embodiment, both the first communication module and the second communication module are physical communication modules.

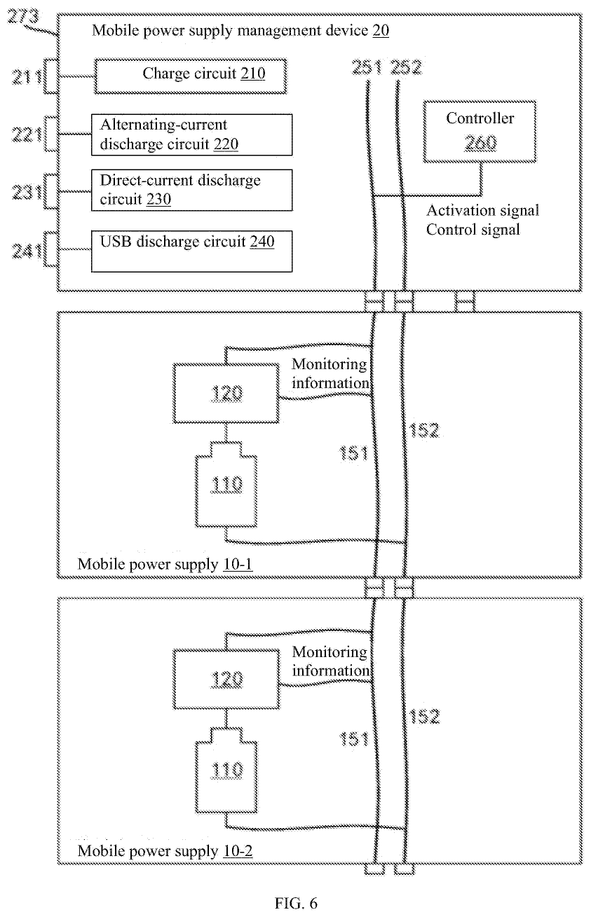

FIG. 6 is a block diagram of another mobile power supply system according to embodiments of the present disclosure. The mobile power supply system includes a mobile power supply management device 20 and two mobile power supplies 10-1 and 10-2. After the mechanical connection between the mobile power supply management device 20 and the two mobile power supplies 10-1 and 10-2 is achieved through a mechanical connection mechanism, a second power interface module 280 of the mobile power supply management device 20 is docked with a first power interface unit 1810 of the mobile power supply 10-1, and a second power interface unit 1820 of the mobile power supply 10-1 is docked with a first power interface unit 1810 of the mobile power supply 10-2. In this embodiment, both the first communication module and the second communication module are power carrier communication modules. Each of the mobile power supply management device 20 and the mobile power supplies 10 also includes a carrier signal generation circuit and a carrier signal reception circuit (not shown, in FIG. 6). The carrier signal generation circuit of the mobile power supply management device 20 generates a power carrier signal based on information to be transmitted, and loads the power carrier signal onto the busbar 251 or 252, The information to be transmitted is for example such as an activation signal and a control signal sent by the controller 260. The carrier signal reception circuit of the mobile power supply 10-1 or 10-2 can obtain the power carrier signal from the busbars 151 and 152, and further obtain information sent by the mobile power supply management device 20 based on the power carrier signal. The carrier signal generation circuit of the mobile power supply 10-1 or 10-2 generates a power carrier signal based on monitoring information about the battery 110 reported by the battery control circuit 120, and loads the power carrier signal onto the busbar 151 or 152. The carrier signal reception circuit of the mobile power supply management device 20 detects the power carrier signal sent by the mobile power supply 10 from the busbars 251 and 252, and further obtains information sent by the mobile power supply based on the power carrier signal. The mobile power supply management device 20 communicates with the mobile power supply 10 through power line communication technology, without the need for communication signal lines and communication interfaces.

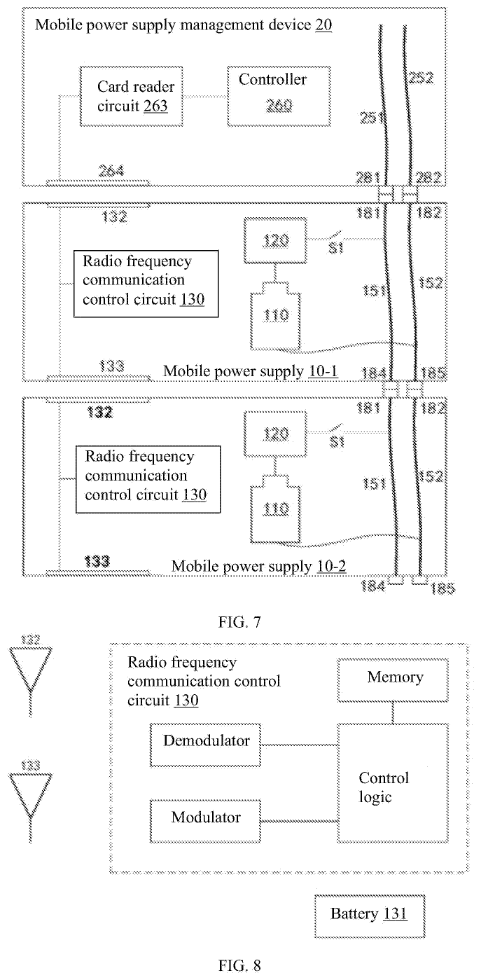

FIG. 7 is a block diagram of still another mobile power supply system according to embodiments of the present disclosure. The mobile power supply system includes a mobile power supply management device 20 and two mobile power supplies 10-1 and 10-2. After the mechanical connection between the mobile power supply management device 20 and the two mobile power supplies 10-1 and 10-2 is achieved through a mechanical connection mechanism, a second power interface module 280 of the mobile power supply management device 20 is docked with a first power interface unit 1810 of the mobile power supply 10-1, and a second power interface unit 1820 of the mobile power supply 10-1 is docked with a first power interface unit 1810 of the mobile power supply 10-2. In this embodiment, both the first communication module and the second communication module are radio frequency communication modules. The second communication module of the mobile power supply management device 20 includes a card reader circuit 263 and a third radio frequency antenna 264. The card reader circuit 263 and the third radio frequency antenna 264 are both arranged in the second space formed by the second housing 270, The third radio frequency antenna 264 is arranged on an inner side of the lower wall 272 of the second housing 270, for example.

The first communication module of each of the mobile power supplies 10-1 and 10-2 includes a radio frequency communication control Circuit 130 (also known as an RFID control circuit), a first radio frequency antenna 132, and a second radio frequency antenna 133. The first radio frequency antenna 132 is for example arranged on an inner side of the upper wall 171 of the first housing 170, and the second radio frequency antenna 133 is for example arranged on an inner side of the lower wall 172 of the first housing 170. The first radio frequency antenna 132 is used for communication with an upper-level mobile power supply, and the second radio frequency antenna 133 is used for communication with a lower-level mobile power supply. The radio frequency communication control circuit 130 is coupled to the first radio frequency antenna 132 and the second radio frequency antenna 133. When the mobile power supplies 10 and the mobile power supply management device 20 are combined, the plurality of mobile power supplies 10 and the mobile power supply management device are stacked, and the radio frequency communication control circuit 130 can communicate with the upper-level mobile power supply or the mobile power supply management device through the first radio frequency antenna 132 and communicate with the lower-level mobile power supply through the second radio frequency antenna 133. The radio frequency communication control circuit 130 includes an RFID protocol layer chip.

FIG. 8 is a block diagram of a radio frequency communication control circuit. The radio frequency communication control circuit 130 includes a modulator, a demodulator, control logic, a memory, and a battery 131, A signal received through the first radio frequency antenna 132 or the second radio frequency antenna 133 is processed by the demodulator and is supplied to the control logic. A signal sent by the control logic is processed by the modulator and is sent outwards through the first radio frequency antenna 132 or the second radio frequency antenna 133. The memory stores information about the mobile power supply 10, such as the model and, user identification (UID) of the mobile power supply 10 the capacity of the battery 110, and UID of the mobile power supply management device that is allowed to be accessed. The control logic, for example, performs verification of an activation signal based on the information in the memory. The control logic is coupled to the battery control circuit 120, and can achieve communication between the battery control circuit 120 and the mobile power supply management device 20. The mobile power supply management device 20 conducts charging and discharging management based on information reported by the battery control circuit 120 and sends a command to the battery control circuit 120.

When the mobile power supply 10 is in a standby mode, the radio frequency communicator control circuit 130 is in a passive state, and the battery 131 does not supply power to the radio frequency communication control circuit 130, the first radio frequency antenna 132, and the second radio frequency antenna 133, After the first radio frequency antenna 132 receives the activation signal, the activation signal is verified through the radio frequency communication control circuit 130 by using energy of the activation signal. The activation signal is either an activation signal directly sent by the card reader circuit 230 or an activation signal generated by the card reader circuit 230 and forwarded by other mobile power supplies 10. In response to the successful verification of the activation signal, the radio frequency communication control circuit 130 generates a battery activation signal. The battery activation signals is for example a low-level signal. In response to the battery activation signal, the battery 131 supplies power to the radio frequency communication control circuit 130, and the radio frequency communication control circuit 130 changes from the passive state to an active state. The radio frequency communication control circuit 130 responds to the activation signal through the first radio frequency antenna 132 and sends a response signal to the card reader circuit 230. The radio frequency communication control circuit 130 also forwards the activation signal to other mobile power supplies 10 through the second radio frequency antenna 133.

The radio frequency communication control circuit 131) in the active state can achieve communication between the battery control circuit 120 and the mobile power supply management device 20. In response to the successful verification of the activation signal, the radio frequency communication control circuit 130 also activates the battery control circuit 120. For example, the radio frequency communication control circuit 130 causes the battery control circuit 120 to enter the working state from the sleep state, and the radio frequency communication control circuit 130 causes a switch S1 between the battery control circuit 120 and the busbar 151 to turn on from a turn-off state. In response to successful verification of a shutdown signal received by the first radio frequency antenna 132, the radio frequency communication control circuit 130 in the active state forwards the shutdown signal through the second radio frequency antenna 133. After a predetermined time, the battery 131 stops supplying power to the radio frequency communication control, circuit 130, and the radio frequency communication control circuit 130 changes from, the active state to the passive state. The shutdown signal is directly sent by the card reader circuit 230 or is generated by the card, reader circuit 230 and forwarded by other mobile power supplies.

In some embodiments, the radio frequency communication control circuit 130 also includes an encryption circuit and a decryption circuit. The encryption circuit can encrypt signals to be sent by the radio frequency antenna through encryption algorithms or private key privatization. The decryption circuit is used to decrypt signals received by the radio frequency antenna. In this way, the communication between the mobile power supply 10 and the mobile power supply management device is more secure and is convenient for management, maintenance, and mass production.

In some embodiments, in response to successful verification of an access signal of the card reader circuit 230, the radio frequency communication control circuit 130 sends the information about the mobile power supply 10 to the card reader circuit 230, which can facilitate the user's selection of the mobile power supply 10.

Since the mobile power supply and the mobile power supply management device communicate with each other through near-field communication technology, the mobile power supply and the mobile power supply management device do not need any physical communication module. The mobile power supply may include only a power interface, which is more safe, convenient, and reliable. For mobile power supplies that communicate through power carriers, it is also necessary to consider issues such as high common mode voltage and electrostatic impact. Communication components of the mobile power supply in this embodiment are relatively independent of the battery and are neither affected by the battery and parallel busbars, nor need to consider issues such as high common mode voltage and electrostatic impact involved in power carrier communication. By encryption or verification in near-field communication, the confidentiality level of communication data can also be improved, making it difficult for mobile power supplies to be cracked, damaged, or mistakenly triggered. In the standby mode, the radio frequency communication control circuit 130 is in the passive state, realizing zero power consumption.

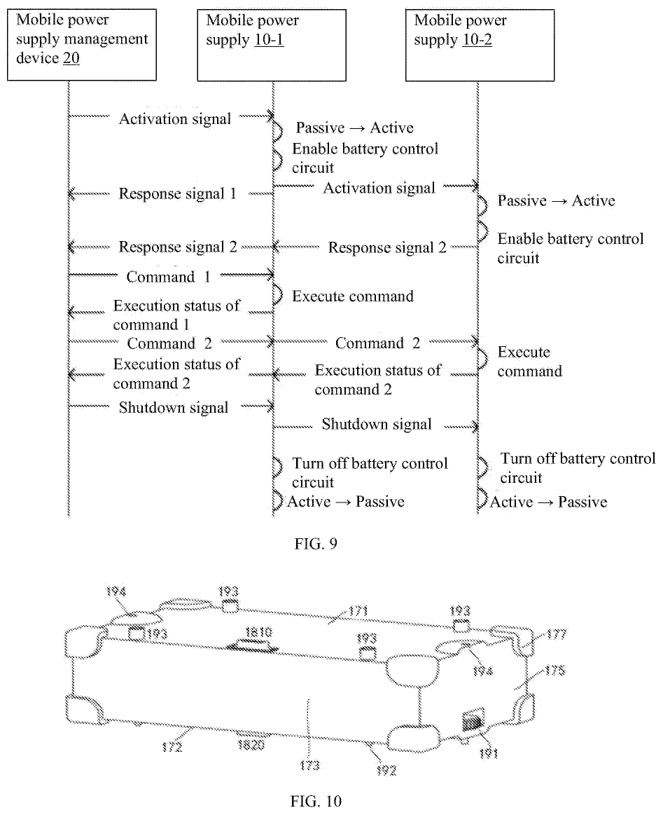

FIG. 9 shows a workflow of the mobile power supply system in FIG. 7. As an example, the mobile power supply system includes two mobile power supplies. Before the workflow starts, both mobile power supplies 10-1 and 10-2 are in the standby mode, with their radio frequency communication control circuits 130 in the passive state. The card reader circuit 230 of the mobile power supply management device 20 sends an activation signal through the third radio frequency antenna 232.

After the successful verification of the activation signal by the radio frequency communication control circuit 130 of the mobile power supply 10-1, the battery 131 supplies power to the radio frequency communication control circuit 130. The radio frequency communication control circuit 130 changes from the passive state to the active state, and the radio frequency communication control circuit 130 enables the battery control circuit 120. The radio frequency communication control circuit 130 forwards the activation signal to the mobile power supply 10-2 through the second radio frequency antenna 133, and a response signal 1 is sent to the card reader circuit 230 of the mobile power supply management device 20 through the first radio frequency antenna 132.

After the successful verification of the activation signal by the radio frequency communication control circuit 130 of the mobile power supply 10-2, the battery 131 supplies power to the radio frequency communication control circuit 130, The radio frequency communication control circuit 130 changes from the passive state to active state, and the radio frequency communication control circuit 130 enables the battery control circuit 120. The radio frequency communication control circuit 130 sends a response signal 2 to the mobile power supply through the first radio frequency antenna 132. The mobile power supply 10-1 forwards the response signal 2 to the card reader circuit 230 of the mobile power supply management device 20.

The card reader circuit 230 of the mobile power supply management device 20 sends a command 1 to the mobile power supply 10-1 and a command 2 to the second mobile power supply 10-2. The commands 1 and 2, for example, are used to achieve parallel connection between the battery 110 of the mobile power supply 10-1 and the battery 110 of the mobile power supply 10-2 to supply power to the electric device. For example, the commands 1 and 2 are used to realize charging of the battery 110 of the mobile power supply 10-1 and the battery 110 of the mobile power supply 10-2. The command 2 is forwarded through the mobile power supply 10-1.

The mobile power supply 10-1 and the mobile power supply 10-2 execute the commands and send execution statuses of the command 1 and the command 2 to the mobile power supply management device 20, respectively. The execution statuses of the commands 1 and 2 includes a status of the battery 110 monitored by the battery control circuit 120, including a voltage, a charge current, a discharge current, and a temperature of the battery 110, It can be understood that the execution status of the command 2 is forwarded through the mobile power supply 10-1.

The card reader circuit 230 of the mobile power supply management device 20 sends a shutdown signal to the mobile power supply 10-1, After successful verification of the shutdown signal, the mobile power supply 10-1 forwards the shutdown signal to the mobile power supply After a predetermined time after forwarding the shutdown signal, the mobile power supply turns off the battery control circuit 120, the battery 131 stops supplying power to the radio frequency communication control circuit 130, and the radio frequency communication control circuit 130 changes from the active state to the passive state. After verifying the shutdown signal, the mobile power supply 10-2 turns off the battery control circuit 120, the battery 131 stops supplying power to the radio frequency communication control circuit 130, and the radio frequency communication control circuit 130 changes from the active state to the passive state.

The first and second mechanical connection mechanisms of the mobile power supply 10, the third mechanical connection mechanism of the mobile power supply management device 20, and cooperation among the mechanical connection mechanisms for achieving the mechanical connection between the mobile power supply management device 20 and the mobile power supply and between the mobile power supplies 10, will be introduced below with reference to embodiments.

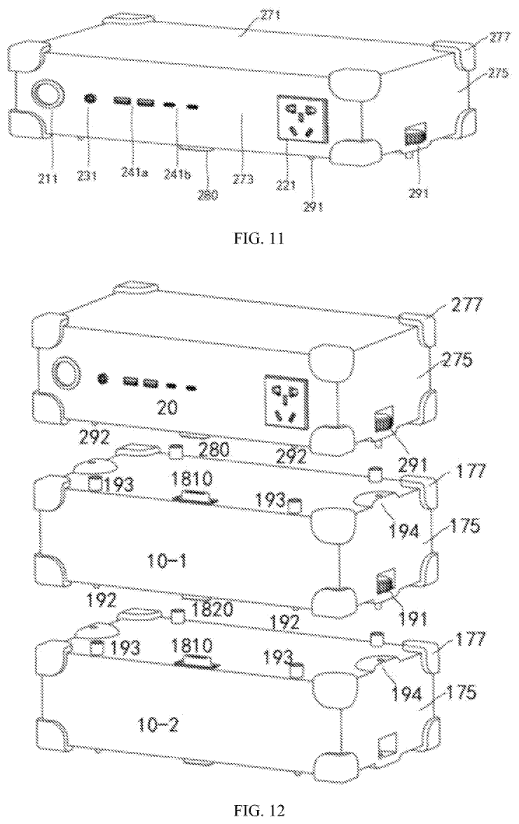

FIG. 12 is a schematic view of a mobile power supply system in an uncombined state according to a first embodiment of the present disclosure. In the first embodiment, a mobile power supply management device 20 and one or more mobile power supplies 10 are mechanically connected through screws and screw holes. The mobile power supply system shown in FIG. 12 includes the mobile power supply management device 20 and mobile power supplies 10-1 and 10-2.

The third mechanical connection mechanism of the mobile power supply management device includes at least one screw 291. The lower wall 272 of the second housing 270 of the mobile power supply management device 20 includes a screw hole corresponding to the screw 291, and the screw hole is at an edge of the lower wall 272 and close to the side wall. For example, as shown in FIG. 10, screws 291 are arranged close to a side wall 275 of the second housing 270 and close to a side wall opposite to the side wall 275. The side wall of the second housing 270 has an opening corresponding to the screw 291, and the opening is used to expose a cap of the screw 291, The cap of the screw 291 is provided with a pattern to increase friction when the user rotates the screw 291.

The first mechanical connection mechanism of the mobile power supply 10-1 includes a screw hole 194. The screw hole 194 is arranged on the upper wall 171 of the first housing 170 of the mobile power supply 10-1 and is fitted with the screw 291. For example, the screw hole 194 and the screw 291 are each provided with matching threads. By rotating the screw 291, the screw 291 is fitted with the screw hole on the lower wall 272 of the second housing 270 of the mobile power supply management device 20 and the screw hole 194 on the upper wall 171 of the first housing 170 of the mobile power supply 10-1, to achieve fixed connection between the mobile power supply management device 20 and the mobile power supply 10. By rotating the screw 291 in a reverse direction, the fixed connection between the mobile power supply management device and the mobile power supply 10 can be released. Similarly, the second mechanical connection mechanism of the mobile power supply 10-1 includes a screw 191, and the first mechanical connection mechanism of the mobile power supply 10-2 includes a screw hole 194. The screw 191 of the mobile power supply 10-1 is fitted with the screw hole 194 of the mobile power supply 10-2, to achieve fixed connection between the mobile power supply 10-1 and the mobile power supply 10-2. The arrangement of the screw 191 is similar to that of the screw 291.

The third mechanical connection mechanism of the mobile power supply management device also includes a mounting protrusion 292 on the lower wall 272 of the second housing 270 of the mobile power supply management device 20. The number of mounting protrusions 292 is not limited, and for example, there are four mounting, protrusions. The first mechanical connection mechanism of the mobile power supply 10-1 also includes an accommodation hole 193 on the upper wall 171 of the first housing 170 of the mobile power supply 10-1. A hole wall of the accommodation hole 193 protrudes from, the upper wall 171 of the first housing 170 of the mobile power supply 10, and the accommodation hole 193 is used to accommodate the mounting protrusion 292. The accommodation hole 193 is fitted with the mounting protrusion 292, which can facilitate alignment of the mobile power supply management device 20 and the mobile power supply 10. After the alignment of the mobile power supply management device 20 and the mobile power supply 10, the screw 291 is rotated to achieve the fixed connection between the mobile power supply management device 20 and the mobile power supply 10. Similarly, the second mechanical connection mechanism of the mobile power supply 10-1 also includes a mounting protrusion 191 on the lower walla 172 of the first housing 170 of the mobile power supply 10-1, and the second mechanical connection mechanism of the mobile power supply 10-2 also includes an accommodation hole 193.

The third mechanical connection mechanism of the mobile power supply management device and the first mechanical connection mechanism of the mobile power supply 10-1 cooperate to achieve a detachable mechanical connection between the mobile power supply management device 20 and the mobile power supply 10-1, The second mechanical connection mechanism of the mobile power supply 10-1 and the first mechanical connection mechanism of the mobile power supply 10-2 cooperate to achieve a detachable mechanical connection between the mobile power supply 10-1 and the mobile power supply 10-2. When the mobile power supply management device 20 and the mobile power supply 10-1 are mechanically connected, the second power interface module 280 of the mobile power supply management device 20 is docked with the first power interface unit 1810 of the mobile power supply 10-1. When the mobile power supply 10-1 and the mobile power supply 10-2 are mechanically connected, the second power interface unit 1820 of the mobile power supply 10-1 is docked with the first power interface unit 1810 of the mobile power supply 10-2.

In some embodiments, the third mechanical connection mechanism of the mobile power supply management device 20 includes a screw hole on the lower wall 272 of the second housing 270, the first mechanical connection mechanism of the mobile power supply 10 includes a screw, and the second mechanical connection mechanism of the mobile power supply 10 includes a screw hole on the lower wall of the first housing 170, The screw of the mobile power supply 10 passes through the screw hole on the upper wall of the mobile power supply 10 and the screw hole on the lower wall of the mobile power supply management device 20. The side wall of the mobile power supply 10 has an opening for exposing a cap of the screw.

In a second embodiment, the mobile power supply management device 20 and the one or more mobile power supplies 10 are mechanically connected through a buckle.

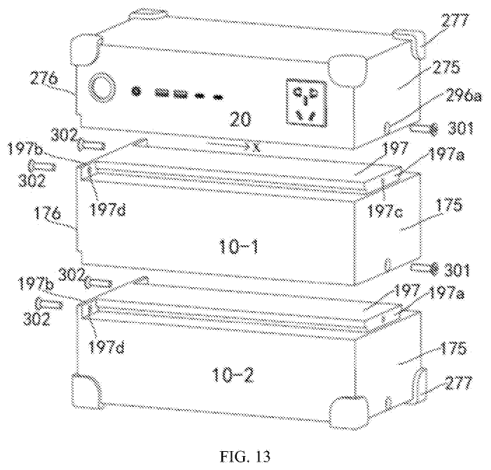

FIG. 13 is a schematic view of a mobile power supply system in an uncombined state according to a third embodiment of the present disclosure. In the third embodiment, a mobile power supply management device 20 and one or more mobile power supplies 10 are mechanically connected through slide grooves and slide blocks as well as screws. The mobile power supply management device 20 includes a slide groove or a slide block. One of upper and lower walls of the mobile power 10 includes a slide groove and the other thereof includes a slide block. The mobile power supply system shown in FIG. 13 includes the mobile power supply management device 20 and mobile power supplies 10-1 and 10-2.

The third mechanical connection mechanism of the mobile power supply management device includes a slide groove (not shown). The slide groove is on the lower wall 272 of the second housing 270 of the mobile power supply management device 20. In a length direction X of the slide groove (with a side wall 276 pointing towards the side wall 275), the slide groove has a first end provided with an opening and a second end provided with an end wall. The second end of the slide groove is on the side wall 275 of the second, housing 270 of the mobile power supply management device 20, and the side wall 275 serves as the end wall of the slide groove, the end wall having a hole 296a. The opening of the slide groove is on the side wall 276 of the second housing 270 of the mobile power supply management device 20, the side wall 276 being opposite to the side wall 275. The side wall 276 at the opening of the slide groove retracts inwards by a predetermined distance, and the side wall 276 includes screw holes on both sides of the opening of the slide groove.

The first mechanical connection mechanism of the mobile power supply 10-1 includes a slide block 197 arranged on the upper wall 171 of the first housing 170 of the mobile power supply 10-1. The slide block 197 has a first end 197a and a second end 197b in its length direction. In the length direction of the slide block 197, the first end 197a of slide block 197 retracts inwards by, a predetermined distance compared to the side wall 175, to adapt to an end wall of the mobile power supply management device 20. The first end 197a has a screw hole 197c corresponding to the hole 296a. The second end 197b of the slide block 197 is arranged on the side wall 176 of the first housing 170, and the side wall 176 has a hole 197d corresponding to the screw holes on the side wall 276 of the mobile power supply management device 20, The slide block 197 slides into, the slide groove along the direction X until the first end 197a of slide block 197 abuts against the end wall of the slide groove, and the second end 197b of slide block 197 abuts against the side wall 276 at the opening of the slide groove. A screw 301 is inserted the screw hole 197c after passing through the through hole 296a, A screw 302 is inserted into the screw holes on the side wall 276 of the mobile power supply management device 20 after passing through the hole 197d. The mobile power supply management device 20 and the mobile power supply 10-1 are fixedly connected through the screws and the screw holes. By uncoupling the screws and the screw holes, the slide block slides out of the slide groove, and the connection between the mobile power supply management device 20 and the mobile power supply 10-1 can be released. It can be understood that after the slide block 197 of the mobile power supply 10-1 slides into the slide groove of the mobile power supply management device 20, fixation can be realized by other means, such as the buckle in the second embodiment, which will not be limited in the present disclosure.

Furthermore, an upper part of the slide block 197 has a width greater than a lower part of the slide block 197, and the slide groove has a corresponding sectional shape. In such a way, the firmness of the connection between the mobile power supply management device 20 and the mobile power supply 10-1 can be enhanced, especially when the mobile power supply system is transferred.

Similarly, the second mechanical connection mechanism of the mobile power supply 104 includes a slide groove on the lower wall 172, and the first mechanical connection mechanism of the mobile power supply 10-2 includes a slide block 197 on the upper wall 171. After the slide block 197 of the mobile power supply 10-2 slides into the slide groove of the mobile power supply the mobile power supply 10-1 and the mobile power supply 10-2 can be fixed through the coupling of screws and screw holes.

IA the embodiment shown in FIG. 13, the interface module 280 of the mobile power supply management device 20 may be arranged on the end wall of the slide, groove, and the first interface module 1810 of the mobile power supply 10-1 is arranged on the first end 197a of the slide block 197. When the first end 197a of the slide block 197 abuts against the end wall of the slide groove, the second power interface module 280 is docked with the first power interface unit 1810. Similarly, the second power interface unit 1820 of the mobile power supply 10-1 is arranged on the end wall of the slide groove of the second mechanical connection mechanism of the mobile power supply 10-1, and the first power interface unit 1810 of the mobile power supply 10-2 is arranged on the first end 197a of the slide block 197 of the first mechanical connection mechanism of the mobile power supply 10-2.

In some embodiments, the third mechanical connection mechanism of the mobile power supply management device 20 includes a slide block arranged on the lower wall 272 of the second housing 270, and the first mechanical connection mechanism of the mobile power supply 10 includes a slide groove arranged on the upper wall 175 of the first housing 170.

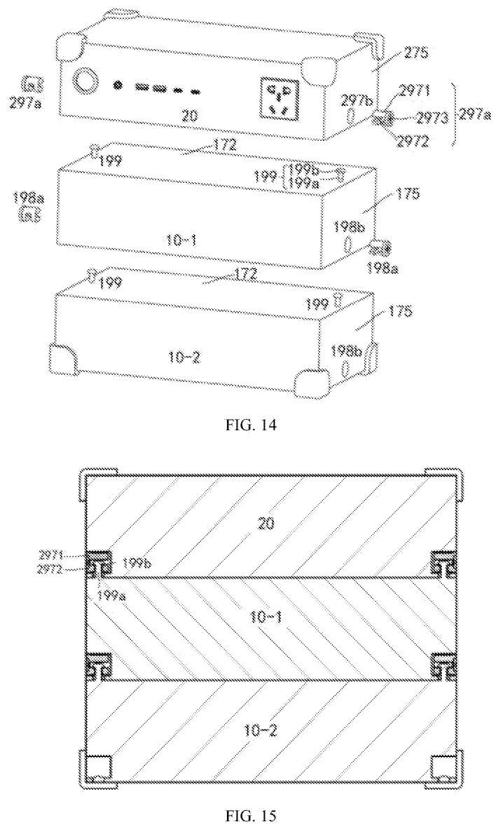

FIG. 14 is a schematic view of a mobile power supply system in an uncombined state according to a fourth embodiment of the present disclosure. FIG. 15 is a sectional view of the mobile power supply system in a combined state according to the fourth embodiment of the present disclosure.

In the fourth embodiment, a mobile power supply management device 20 and one or more mobile power supplies 10 are mechanically connected by riveting. The mobile power supply management device 20 and the one or more mobile power supply 10 are each provided with a second clamping member and a first clamping member. The mobile power supply system shown in FIGS. 14 and 15 includes the mobile power supply management device 20 and mobile power supplies 10-1 and 10-2.

The third mechanical connection mechanism of the mobile power supply management device includes at least one first clamping member 297a. At least one side wall of the second housing 270 of the mobile power supply management device 20 includes an opening 297b for accommodating the first clamping member 297a. For example, as shown in FIGS. 14 and 15, openings 297b are arranged on the side wall 275 of the housing 270 and another side wall opposite to the side wall 275.

The first mechanical connection mechanism of the mobile power supply 10-1 includes a second clamping member 199 arranged on the upper wall 171 of the first housing 170 of the mobile power supply 10-1. The second clamping member 199 includes a base part 199a and a cap part 199b. The base part 199a is rod-shaped, for example, and the cap part 199b has a width greater than the base part 199a.

The first clamping member 297a includes a base portion 2973, a side wall 2971 connected to the base portion 2973, and two arm portions 2972 extending from the side wall 2971. The base portion 2973 has a cross-shaped recess for users to use a tool to rotate the first clamping member 297a, The side wall 2971 and the two arm portions 2972 define a space capable of accommodating the cap part 199b of the second clamping member 199. A distance between the two arm portions 2972 allows the base part 199a of the second clamping member 199 to pass through.

After the mobile power supply management device 20 is aligned with the mobile power supply 10-1, the first clamping member 297a is inserted into the opening 297, and the first clamping member 297a is rotated to engage with the second clamping member 199. As shown in FIG. 15, after the first clamping member 297a engages with the second clamping member 199, the two arm portions 2972 of the first clamping member 297a abut against a lower surface of the cap part 199b of the second clamping member 199, and an inner surface of the side wall 2971 abuts against an upper surface of the cap part 199b of the second clamping member 199, The fixed connection between the mobile power supply management device 20 and the mobile power supply 10 is achieved through the first, clamping member 297a and the second clamping member 199. Rotating the first clamping member 297a in a reverse direction can release the fixed connection between the mobile power supply management device 20 and the mobile power supply 10.

Similarly, the second mechanical connection mechanism of the mobile power supply 10-1 includes a first clamping member 198a and an opening 198b that is on the side wall. The first mechanical connection mechanism of the mobile power supply 10-2 includes a second clamping member 199. The first clamping member 195a of the mobile power supply 10-1 and the second clamping member 199 of the mobile power supply 10-2 cooperate to achieve the fixed connection between the mobile power supply 10-1 and the mobile power supply 10-2.

It can be understood that the third mechanical connection mechanism of the mobile power supply management device 20, and the first and second mechanical connection mechanisms of the mobile power supply 10 are not limited to the forms in the first to fourth embodiments described above. For example, the detachable connection between the mobile power supply management device 20 and the mobile power supply 10 is achieved through screws and buckles. The mobile power supply management device 20 and the mobile power supply 10 are first locked together through buckles, and then the mechanical connection between the mobile power supply management device 20 and the mobile power supply 10 is strengthened through screws for firmness and reliability.

In the embodiments of the present disclosure, the mobile power supply includes the battery for supplying power to the external electric device, and the mobile power supply management device includes the charge circuit and the discharge circuit for charging and discharging of the battery in the mobile power supply. The charge circuit and the discharge circuit are arranged separately from the battery. Both the mobile power supply and the mobile power supply management device are provided with interface modules to achieve electric connection between the mobile power supply and the mobile power supply management device, Since the mobile power supply and the mobile power supply management device are detachably mechanically connected, and the mobile power supplies are detachably mechanically connected, the recombination of the mobile power supply system can be facilitated. The plurality of mobile power supplies may have different battery capacities and/or discharge powers. The number and power of mobile power supplies in the mobile power supply system can be adjusted according to demands, different battery capacities and discharge powers are combined to meet various application scenarios, which can solve the problem that each battery configured with one charge circuit and one discharge circuit can only be used in limited application scenarios, Additionally, the model of mobile power supplies can be simplified and manufacturers' design costs can be saved.

Accordingly, embodiments of the present disclosure provide a mobile power supply, a mobile power supply management device, and a mobile power supply system. The mobile power supply and the mobile power supply management device can be combined in the light of demands, which improves the adaptability to different electricity usage scenarios. Detachable mechanical connections between the mobile power supply management device and the mobile power supply and between mobile power supplies can facilitate recombination of the mobile power supply system.

According to a first aspect of embodiments of the present disclosure, a mobile power supply is provided. The mobile power supply includes: a first housing enclosing and forming a first space; a battery accommodated in the first space; a battery control circuit coupled to the battery and accommodated in the first space; a first communication module coupled to the battery control circuit and accommodated in the first space, the first communication module being configured to communicate with a mobile power supply management device; a first power interface module arranged on the first housing and configured for power connection between the battery and the mobile power supply management device; a first mechanical connection mechanism arranged on the first housing, the first mechanical connection mechanism being configured to cooperate with a mechanical connection structure of an upper-level mobile power supply to mechanically connect the mobile power supply with the upper-level mobile power supply; and a second mechanical connection mechanism arranged on the first housing and spaced apart from the first mechanical connection mechanism, the second mechanical connection mechanism being configured to cooperate with a mechanical connection structure of a lower-level mobile power supply to mechanically connect the mobile power supply with the lower-level mobile power supply.

In a possible implementation, the first communication module is at least one of a physical communication module, a power carrier communication module, and a radio frequency communication module.

In a possible implementation, the first communication module includes a first radio frequency antenna, a second radio frequency antenna, and a radio frequency communication control circuit that is coupled to the first radio frequency antenna and the second radio frequency antenna. The first radio frequency antenna cooperates with a radio frequency antenna of the upper-level mobile power supply and is configured for communication between the mobile power supply and the upper-level mobile power supply. The second radio frequency antenna cooperates with a radio frequency antenna of the lower-level mobile power supply and is configured for communication between the mobile power supply and the lower-level mobile power supply.

In a possible implementation, in response to successful verification of an activation signal received by the first radio frequency antenna, the radio frequency communication control circuit changes from a passive state to an active state.

In a possible implementation, the first radio frequency antenna receives a shutdown signal and after a predetermined delay, the radio frequency communication control circuit changes from the active state to the passive state.

According to a second aspect of embodiments of the present disclosure, a mobile power supply management device is provided. The mobile power supply management device includes: a second housing enclosing and forming a second space; a discharge circuit accommodated in the second space; a second power interface module arranged on the second housing and configured for power connection between the mobile power supply management device and a battery of a mobile power supply; a second communication module configured to communicate with a battery control circuit of the mobile power supply and accommodated in the second space; and a third mechanical connection mechanism arranged on the second housing, the third mechanical connection mechanism being configured to cooperate with a mechanical connection structure of the mobile power supply to mechanically connect the mobile power supply management device with the mobile power supply.

In a possible implementation, the second communication module is at least one of a physical communication module, a power carrier communication module, and a radio frequency communication module.

In a possible implementation, the discharge circuit includes at least one of a direct-current discharge circuit and an alternating-current discharge circuit.

In a possible implementation, the second communication module includes a third radio frequency antenna and a card reader circuit.

According to a third aspect of embodiments of the present disclosure, a mobile power supply system is provided. The mobile power supply system includes: one or more mobile power supplies and a mobile power supply management device. Each mobile power supply includes: a first housing enclosing and forming a first space; a battery accommodated in the first space; a battery control circuit coupled to the battery and accommodated in the first space; a first communication module coupled to the battery control circuit and accommodated in the first space, the first communication module being configured to communicate with a mobile power supply management device; a first power interface module arranged on the first housing and configured for power connection between the battery and the mobile power supply management device; a first mechanical connection mechanism arranged on the first housing, the first mechanical connection mechanism being configured to cooperate with a mechanical connection structure of an upper-level mobile power supply to mechanically connect the mobile power supply with the upper-level mobile power supply; and a second mechanical connection mechanism arranged on the first housing and spaced apart from the first mechanical connection mechanism, the second mechanical connection mechanism being configured to cooperate with a mechanical connection structure of a lower-level mobile power supply to mechanically connect the mobile power supply with the lower-level mobile power supply. The mobile power supply management device includes: a second housing enclosing and forming a second space; a discharge circuit accommodated in the second, space; a second power interface module arranged on the second housing and configured for power connection between the mobile power supply management device and a battery of a mobile power supply: a second communication module configured to communicate with a battery control circuit of the mobile power supply and accommodated in the second space; and a third mechanical connection mechanism arranged on the second housing, the third mechanical connection mechanism being configured to cooperate with a mechanical connection structure of the mobile power supply to mechanically connect the mobile power supply management device with the mobile power supply. The mobile power supply management device sends an activation signal to the mobile power supply through the second communication module, and the activation signal is used to activate a battery control circuit of the mobile power supply.

In a possible implementation, the mobile power supply system includes a plurality of mobile power supplies, and batteries of the plurality of mobile power supplies are connected in parallel.

In a possible implementation, when the batteries of the plurality of mobile power supplies are charged the battery with the lowest power level, among the plurality of mobile power supplies is first charged.

In the embodiments of the present disclosure, the mobile power supply includes the battery for power supply to the external electric device, and the battery of the mobile power supply supplies power to the external electric device through the discharge circuit of the mobile power supply management device, Each of the mobile power supply and the mobile power supply management device is provided with the power interface module, and the battery of the mobile power supply and the discharge circuit of the mobile power supply management device are connected through the busbar and the power interface module. Different mobile power supplies may have different battery capacities or powers. The mobile power supply and the mobile power supply management device are detachably mechanically connected through the mechanical connection mechanisms to achieve cascade connection. The number and power of mobile power supplies in the mobile power supply system can be adjusted according to demands, achieving different battery capacities and discharge capabilities, and adapting to personalized application scenarios.

It should be noted that in the present disclosure, terms such as “first” and “second” are only used for ease of description of different components or designations and are not intended to indicate or imply sequential relationship or relative importance, or to imply the number of indicated technical features. Thus, the feature defined, with “first” and “second” may comprise one or more of this feature.

Unless otherwise defined, all technical and scientific terms used herein have the same meanings as those commonly understood by technical personnel in the field of the present disclosure. The terms used in the specification of the present disclosure herein are only intended to describe specific embodiments rather than limit the present disclosure.

It should be noted that although specific embodiments of the present disclosure have been described in detail with reference to the accompanying drawings, the description should not be understood as limitation on the protection scope of the present disclosure. Within the scope defined in the claims, various modifications and variations that can be made by those skilled in the art without creative effort still fall within the protection scope of the present disclosure.

Examples of the embodiments of the present disclosure aim to concisely explain the technical features of the embodiments of the present disclosure and enable those skilled in the art to have a direct understanding on the technical features of the embodiments of the present disclosure, and do not constitute improper limitation on the embodiments of the present disclosure.

Finally, it should be noted that the above embodiments are used to illustrate rather than limit the technical solutions of the present disclosure. Although this application has been described in detail with reference to the aforementioned embodiments, ordinary technical personnel in the art should understand that they can still modify the technical solutions in the aforementioned embodiments or equivalently replace some of the technical features, and these modifications or replacements do not make the corresponding technical solutions depart from the scope of technical solutions of various embodiments of the present disclosure.

What is claimed is:

1. A mobile power supply, comprising:
a first housing enclosing and forming a first space;
a battery accommodated in the first space;
a battery control circuit coupled to the battery and accommodated in the first space;
a first communication module coupled to the battery control circuit and accommodated in, the first space, the first communication module being configured to communicate with a mobile power supply management device;
a first power interface module arranged on the first housing and configured for power connection between the battery and the mobile power supply management device;
a first mechanical connection mechanism arranged on the first housing, the first mechanical connection mechanism being configured to cooperate with a mechanical connection structure of the mobile power supply management device to mechanically connect the mobile power supply with the mobile power supply management device, or the first mechanical connection mechanism being configured to cooperate with a mechanical connection structure of an external upper-level mobile power supply to mechanically connect the mobile power supply with the upper-level mobile power supply; and
a second mechanical connection mechanism arranged on the first housing and spaced apart from the first mechanical connection mechanism, the second mechanical connection mechanism being configured to cooperate with a mechanical connection structure of an external lower-level mobile power supply to mechanically connect the mobile power supply with the lower-level mobile power supply.

2. The mobile power supply according to claim 1, wherein when the mobile power supply is mechanically connected to the mobile power supply management device or the upper-les el mobile power supply, the first power interface module of the mobile power supply is docked with a power interface module of the mobile power supply management device or the upper-level mobile power supply, to realize power connection between the mobile power supply and the mobile power supply management device or the upper-level mobile power supply.

3. The mobile power supply according to claim 1, wherein the first power interface module comprises:
a first power interface unit configured for power connection between the mobile power supply and the mobile power supply management device or the upper-level mobile power supply; and
a second power interface unit configured for power connection between the mobile power supply and the lower-level mobile power supply.

4. The mobile power supply according to claim 3, wherein:
when the mobile power supply is configured to be mechanically connected to the mobile power supply management device or the upper-level mobile power supply, the first power interface unit of the mobile power supply is configured to be docked with a second power interface unit in a power interface module of the mobile power supply management device or in a power interface module of the upper-level mobile power supply; and
when the mobile power supply is configured to be mechanically connected to the lower-level mobile power supply, the second power interface unit of the mobile power supply is configured to be docked with a first power interface unit in a power interface module of the lower-level mobile power supply.

5. The mobile power supply according to claim 4, wherein:
the first housing comprises an upper wall, a lower wall and a plurality of side walls for enclosing and forming the first space; and
the first power interface unit is arranged on the upper wall of the first housing, and the second power interface unit is arranged on the lower wall of the first housing.

6. The mobile power supply according to claim 3, wherein:
the first communication module is a physical communication module and comprises a signal line, a first communication interface and a second communication interface;
the signal line has a first end coupled to the first communication interface and a second end coupled to the second communication interface, and the signal line serves as a communication path between the battery control circuit and the mobile power supply management device; and
the first communication interface and the first power interface unit are integrated together, and the second communication interface and the second power interface unit are integrated together.

7. The mobile power supply according to claim 6, wherein:
the signal line of the mobile power supply comprises an activation signal line;
the activation signal line is Configured to allow the mobile power supply management device to send an activation signal to the mobile power supply; and
the activation signal is configured to activate the battery control circuit, so that the battery control circuit enters a working state from a sleep state or a low power consumption state.

8. The mobile power supply according to claim 3, wherein:
the first communication module is a power carrier communication module;
the mobile power supply further comprises a first busbar and a second busbar, and the first busbar and the second busbar are coupled to a positive pole and a negative pole of the battery, respectively;
the first power interface unit comprises a first busbar interface and a second busbar interface, and the second power interface unit comprises a third busbar interface and a fourth busbar interface;
the first busbar has a first end coupled to the first busbar interface and a second, end coupled to the third busbar interface, and the second busbar has a first end coupled to the second busbar interface and a second end coupled to the fourth busbar interface;
the mobile power supply further comprises a carrier signal generation circuit and a carrier signal reception circuit, the carrier signal generation circuit is configured to generate a power carrier signal based on information to be transmitted and load the power carrier signal onto the first busbar or the second busbar, and the carrier signal reception circuit is configured to detect a power carrier signal sent by the mobile power supply management device from the first busbar or the second busbar.

9. The mobile power supply according to claim 3, wherein:
the first communication module is a radio frequency communication module;
the first communication module comprises a first radio frequency antenna, a second radio frequency antenna, and a radio frequency communication control circuit that is coupled to the first radio frequency antenna and the second radio frequency antenna;
the first radio frequency antenna cooperates with a radio frequency antenna of the upper-level mobile power supply or of the mobile power supply management device and is configured for communication between the mobile power supply and the upper-level mobile power supply or the mobile power supply management device; and
the second radio frequency antenna cooperates with a radio frequency antenna of the lower-level mobile power supply and is configured for communication between the mobile power supply and the lower-level mobile power supply.

10. A mobile power supply management device, comprising:
a second housing enclosing and forming a second space;
a discharge circuit accommodated in the second space;
a second power interface module arranged on the second housing and configured for power connection between the mobile power supply management device and a battery of a mobile power supply;
a second communication module configured to communicate with a battery control circuit of the mobile power supply and accommodated in the second space; and
a third mechanical connection mechanism arranged on the second housing, the third mechanical connection mechanism being configured to cooperate with a mechanical connection structure of the mobile power supply to mechanically connect the mobile power supply management device with the mobile power supply.

11. The mobile power supply management device according to claim 10, wherein:
the mobile power supply management device comprises a charge circuit, and comprise at least one discharge circuit selected from an alternating-current discharge circuit, a direct-current discharge circuit and a USB discharge circuit;
the second power interface module comprises a fifth busbar interface and a sixth busbar interface;
the mobile power supply management device further comprises a third busbar as a positive-side busbar and a fourth busbar as a negative-side busbar;
the third busbar is coupled to the fifth busbar interface, the fourth busbar is coupled to the sixth busbar interface, and the third busbar and the fourth busbar are both coupled to the charge circuit and the discharge circuit of the mobile power supply management device.

12. The mobile power supply management device according to claim 10, wherein when the mobile power supply management device is mechanically connected to the mobile power supply, the second power interface module of the mobile power supply management device is docked with a power interface module of the mobile power supply, to achieve power connection between the mobile power supply management device and the mobile power supply.

13. The mobile power supply management device according to claim 10, further comprising:
a controller; and
a third communication module configured for communication between the controller and an electronic device at a user side.

14. The mobile power supply management device according to claim 11, wherein:
the second third communication module is a physical communication module and comprises a signal line and a communication interface, to allow a controller of the mobile power supply management device to be coupled to the battery control circuit of the mobile power supply via the signal line and the communication interface.

15. The mobile power supply management device according to claim 11, wherein:
the second third communication module is a power carrier communication module and further comprises a carrier signal generation circuit and a carrier signal reception circuit, wherein the carrier signal generation circuit is configured to generate a power carrier signal based on information to be transmitted and load the power carrier signal onto the third busbar or the fourth busbar, and the carrier signal reception circuit is configured to detect a power carrier signal sent by the mobile power supply from the third busbar or the fourth busbar.

16. The mobile power supply management device according to claim 11, wherein:
the second third communication module is a radio frequency communication module and comprises a card reader circuit and a third radio frequency antenna, wherein the card reader circuit and the third radio frequency antenna are coupled, and the third radio frequency antenna is configured to cooperate with a radio frequency antenna of the mobile power supply and achieve communication between the mobile power supply management device and the mobile power supply.

17. A mobile power supply system, comprising a mobile power supply management device and one or more mobile power supplies, the mobile power supply management device being detachably mechanically connected with the one or more mobile power supplies,
wherein the mobile power supply management device comprises:
a second housing enclosing and forming a second space;
a discharge circuit accommodated in the second space;
a second power interface module arranged on the second housing and configured for power connection between the mobile power supply management device and a battery of a mobile power supply;
a second communication module configured to communicate with a battery control circuit of the mobile power supply and accommodated in the second space; and
a third mechanical connection mechanism arranged on the second housing, the third mechanical connection mechanism being configured to cooperate with a mechanical connection structure of the mobile power supply to mechanically connect the mobile power supply management device with the mobile power supply.

18. The mobile power supply system according to claim 17, wherein each of the one or more mobile power supplies comprises:
a first housing enclosing and forming a first space;
a battery accommodated in the first space;
a battery control circuit coupled to the battery and accommodated in the first space;
a first communication module coupled to the battery control circuit and accommodated in the first space, the first communication module being configured to communicate with a mobile power supply management device;
a first power interface module arranged on the first housing and configured for power connection between the battery and the mobile power supply management device;
a first mechanical connection mechanism arranged on the first housing, the first mechanical connection mechanism being configured to cooperate with a mechanical connection structure of the mobile power supply management device to mechanically connect the mobile power supply with the mobile power supply management device, or the first mechanical connection mechanism being configured to cooperate with a mechanical connection structure of an external upper-level mobile power supply to mechanically connect the mobile power supply with the upper-level mobile power supply; and
a second mechanical connection mechanism arranged on the first housing and spaced apart from the first mechanical connection mechanism, the second mechanical connection mechanism being configured to cooperate with a mechanical connection structure of an external lower-level mobile power supply to mechanically connect the mobile power supply with the lower-level mobile power supply.

19. The mobile power supply system according to claim 18, comprising a plurality of mobile power supplies, wherein batteries of the plurality of mobile power supplies are connected in parallel.

20. The mobile power supply system according to claim 17, wherein the third mechanical connection mechanism of the mobile power supply management device comprises a screw, a first mechanical connection mechanism of each of the one or more mobile power supplies comprises a screw hole, and the mobile power supply management device and the one or more mobile power supplies are mechanically connected through the screw and the screw hole.
